(19) United States
(12) Patent Application Publication
(10) Pub. No.: US 2026/0065905 A1
(43) Pub. Date: Mar. 5, 2026

(54) METHOD AND APPARATUS FOR PROCESSING INPUT UTTERANCES BY A SPEECH RECOGNITION SYSTEM

(71) Applicants: HYUNDAI MOTOR COMPANY, Seoul (KR); KIA CORPORATION, Seoul (KR)

(72) Inventors: Daniel Rim, Hwaseong-si (KR); Chang Woo Chun, Hwaseong-si (KR); Ju Hee Park, Hwaseong-si (KR)

(73) Assignees: HYUNDAI MOTOR COMPANY, Seoul (KR); KIA CORPORATION, Seoul (KR)

(21) Appl. No.: 19/095,412

(22) Filed: Mar. 31, 2025

(30) Foreign Application Priority Data
Aug. 29, 2024 (KR) 10-2024-0117134

(51) Int. Cl. G10L 15/183; G10L 15/18; G10L 15/22; G10L 15/30

(52) U.S. Cl. CPC G10L 15/183; G10L 15/1815; G10L 15/22; G10L 15/30

(57) ABSTRACT

A method and apparatus process input utterances by a speech recognition system. The method and apparatus are implemented by a computer of a speech recognition system to process an utterance that is received as an input. The method includes processing the utterance by a rule-based natural language-understanding engine. The method further includes, when the rule-based natural language-understanding engine fails to process the utterance, converting a representation of the utterance and allowing a machine learning-based natural language-understanding engine to process the utterance by using a large language model (LLM) agent. The method further includes processing the utterance with a converted representation by the machine learning-based natural language-understanding engine.

### CROSS-REFERENCE TO RELATED APPLICATIONS

This application is based on, and claims priority from, Korean Patent Application Number 10-2024-0117134, filed Aug. 29, 2024, the disclosure of which is incorporated by reference herein in its entirety.

### TECHNICAL FIELD

The present disclosure relates to a method and apparatus for enabling a speech recognition system to process input utterances. More specifically, the disclosure relates to a method and apparatus for enabling a speech recognition system to process input utterances by using artificial intelligence.

### BACKGROUND

The statements in this section merely provide background information related to the present disclosure and do not necessarily constitute prior art.

Prior art speech recognition systems are designed by using a single-turn approach. An intent classifier and a slot extractor are used to process user commands, i.e., utterances. Since conventional speech recognition systems use predefined intent classes to recognize and perform commands, they have the advantage of quickly and accurately recognizing the functions supported by the speech recognition system. However, there are multi-turn methods that are context-based, such as human-to-human conversations. Multi-turn methods have limitations. They have difficulty processing utterances that abridge the content of the previous utterance or refer to objects by using pronouns. Another difficulty is to process ambiguous utterances that can be interpreted in more than one way. The field of natural language process defines the former as a co-reference resolution problem and the latter as an ambiguity problem. Conventional speech recognition systems have been developed by identifying co-reference resolution and ambiguity problems by using out-of-domain (OOD) algorithms. The identified OOD utterances are subject to three types of exception handling: misclassification and mis-operation, incomplete recognition, or recognition with guidance to unsupported features.

As large language models (LLMs), a type of generative AI, become more popular and readily available, the importance of multi-turn dialog processing is increasing. However, there is a challenge in introducing generative AI to speech recognition systems. Large language models perform poorly at intent classification, a task traditionally handled by natural language understanding (NLU). Another issue is the cost of running large language models. Because large language models have large parameters, they require large graphics processing unit (GPU) resources to develop and serve. As a result, indiscriminate employment of large language models can end up costing the employer more money and slowing down their service.

### SUMMARY

The following summary presents a simplified summary of certain features. The summary is not an extensive overview and is not intended to identify key or critical elements.

An aspect of the present disclosure is to provide a method and an apparatus for processing input utterances by speech recognition system.

According to at least one embodiment, the present disclosure provides a method implemented by a computer for a speech recognition system to process an utterance that is inputted. The method includes processing the utterance by a rule-based natural language-understanding engine. The method further includes, when the rule-based natural language-understanding engine fails to process the utterance, converting a representation of the utterance and allowing a machine learning-based natural language-understanding engine to process the utterance by using a large language model agent (LLM agent). The method further includes processing the utterance with a converted representation by the machine learning-based natural language-understanding engine.

According to another embodiment, the present disclosure provides an apparatus to process an input utterance, i.e., an utterance that is inputted. The apparatus includes at least one memory configured to store computer-executable instructions and at least one processor. The at least one processor is configured to execute the computer-executable instructions to cause the at least one processor to: process the utterance by a rule-based natural language-understanding engine; when the rule-based natural language-understanding engine fails to process the utterance, convert a representation of the utterance for allowing a machine learning-based natural language-understanding engine to process the utterance by using an LLM agent; and process the utterance with a converted representation by the machine learning-based natural language-understanding engine.

The aspects of the present disclosure are not limited to those mentioned above, and other aspects not mentioned herein will be clearly understood by those skilled in the art from the following description.

These and other features and advantages are described in greater detail below.

### BRIEF DESCRIPTION OF THE DRAWINGS

FIG. 1 is a schematic block diagram of a configuration of a speech recognition system according to at least one embodiment of the present disclosure.

FIG. 2 is a diagram of an illustrative method performed by a large language model agent for processing an input utterance.

FIG. 3 is a flowchart of a speech recognition method according to at least one embodiment of the present disclosure.

FIG. 4 is a schematic diagram of an illustrative configuration of a computing device that may be used to implement the apparatuses and methods described herein.

### DETAILED DESCRIPTION

The present disclosure is directed at solving technical issues including co-reference resolution and ambiguity in the processing of input utterances by a speech recognition system.

The present disclosure is further directed at solving the cost-effectiveness and technical problems of introducing a large language model into a speech recognition system.

The technical issues that the present disclosure is intended to solve are not limited to those mentioned above. Other technical issues not mentioned should be apparent to those of ordinary skill in the art from the description below.

As used below, singular terms may include plural terms unless otherwise specified.

Various embodiments of the present disclosure are described in detail with reference to the accompanying illustrative drawings. In the following description, it should be noted that identical or equivalent elements or components are designated by identical reference numerals even when they are displayed on different drawings. Further, in the following description of various embodiments, a detailed description of related known components and functions when considered to obscure the subject of the present disclosure have been omitted for the purpose of clarity and for brevity.

Additionally, various ordinal numbers or alpha codes such as first, second, i), ii), a), b), and the like, are prefixed solely to differentiate one component from the other but not to imply or suggest the substances, order, or sequence of the components. Throughout this specification, when a part “includes” or “comprises” a component, the part is meant to further include other components, not to exclude thereof unless specifically stated to the contrary.

The description of the present disclosure to be presented below in conjunction with the accompanying drawings is intended to describe various embodiments of the present disclosure and is not intended to represent the only embodiments in which the technical idea of the present disclosure may be practiced.

When a component, device, element, or the like of the present disclosure is described as having a purpose or performing an operation, function or the like, the component, device, or element should be considered herein as being “specifically configured to” meet that purpose or to perform that operation or function.

As used herein, the term “engine” refers to a software-based system, subsystem, or process that is programmed to perform one or more specific functions. An engine may be implemented by at least one or more processors as one or more software modules or components that are installed on one or more computing devices at one or more locations. In some examples, one or more computing devices may be dedicated to a particular engine, or in other examples, multiple engines may run on the same computing device or computing devices.

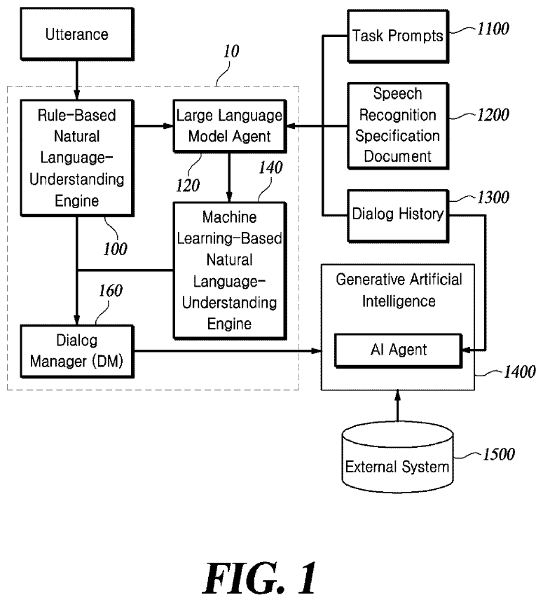

FIG. 1 is a schematic block diagram of a configuration of a speech recognition system according to at least one embodiment of the present disclosure.

Referring to FIG. 1, a speech recognition system 10 is an apparatus that includes a rule-based natural language-understanding engine 100, a large language model agent (LLM agent) 120, and a machine learning-based natural language-understanding engine 140.

The speech recognition system 10 including the rule-based natural language-understanding engine 100, the LLM agent 120, and the machine learning-based natural language-understanding engine 140 may be implemented by a computer or machine, e.g., at least one processor. The speech recognition system 10 may provide the ability to recognize human speech and convert the recognized speech into text or understand it as commands. The speech recognition system 10 enables users to interact with various devices, such as computers, without having to use an input device such as a keyboard or mouse. The speech recognition system 10 may be integrated into systems and devices in a variety of fields. Example systems and devices may include mobile devices such as smartphones, smart appliances, smart speakers, and infotainment systems in automobiles.

The speech recognition system 10 recognizes an utterance of a user upon input thereof, understands the recognized utterance, and provides a service that responds to the utterance of the user. The speech recognition system 10 may include a speech recognizer, e.g., a speech recognition device, that converts the speech utterance of the user into text. The speech recognition device may use at least one speech recognition engine to convert the user's utterance into an input text or an input sentence. The speech recognition engine may refer to a speech-to-text (STT) engine, which may apply a speech recognition algorithm or neural network model to a speech signal representing the utterance of the user, thereby converting the speech signal to text. The speech recognizer may also convert the utterance of the user to text based on a model that is obtained with machine learning or deep learning applied.

The transcribed utterance may be understood by using natural language understanding (NLU) techniques. Natural language understanding is a branch of natural language processing (NLP), which provides computers with the ability to understand human language and determine meaning. Natural language understanding uses three main processes to understand the meaning of an utterance. The first is intent recognition. This is the step of determining the intent of an utterance. For example, the user of the sentence “Tell me the weather” usually intends to get weather information. The second is entity recognition. This is the task of extracting specific elements (entities) from a sentence. For example, in the sentence, “What is the weather in New York tomorrow?”, “New York” and “tomorrow” are the entities. The third is contextual understanding. Natural language understanding involves the ability to understand the meaning of words in context. This is because the same word can have different meanings in different contexts. In particular, in at least one embodiment of the present disclosure, to “process” an utterance or text means to obtain at least one of an intent or an entity as a result of processing the utterance or text.

Embodiments of the present disclosure include two types of natural language-understanding engines including the rule-based natural language-understanding engine 100 and the machine learning-based natural language-understanding engine 140.

The rule-based natural language-understanding engine 100 uses predefined rules and pattern-matching to understand the user's utterance. The rule-based natural language-understanding engine 100 analyzes the structure of the sentence and determines the meaning according to the rules and patterns written by a human. Because the rules are clearly defined, the rule-based natural language-understanding engine 100 has the advantage of fast processing speed and easy debugging. However, if the input data contains expressions that are not defined in advance, the performance of the rule-based natural language-understanding engine 100 may degrade rapidly.

The machine learning-based natural language-understanding engine 140 involves a machine learning algorithm to train itself to learn patterns and meanings of text by using large amounts of data. Using a labeled dataset, the machine learning-based natural language-understanding engine 140 automatically learns intent and entities from text. The algorithm infers and generalizes rules from the data to process new data. Depending on the complexity of the machine learning-based natural language-understanding engine 140, the processing speed can vary. If the trained machine learning-based natural language-understanding engine 140 is optimized, it can work very quickly. In general, well-trained instances of the machine learning-based natural language-understanding engine 140 based on large amounts of data have higher performance and accuracy than rule-based models. However, collecting large amounts of data and training the machine learning-based natural language-understanding engine 140 is time-consuming and expensive.

The rule-based natural language-understanding engine 100 and the machine learning-based natural language-understanding engine 140 have different advantages and disadvantages and can be used in combination. For example, referring to command recognition in smart home control, instructions or commands that are frequently used in smart home systems have relatively simple and fixed forms. In particular, commands such as “turn on the lights,” “raise the temperature,” and “close the door” can be easily processed based on predefined rules. In contrast, a machine learning base is advantageous if the commands uttered by the user are complex. For example, a sentence such as “Turn up the temperature a little higher”, favors a machine learning base. A hybrid approach that combines a rule base and a machine learning base has the advantage of providing both speed of response and accuracy.

The rule-based natural language-understanding engine 100 handles specification-defined unambiguous utterances, utterances that need to be handled, and utterances that are difficult for the machine learning-based natural language-understanding engine 140 to handle. Commands and formal utterances that are supported by traditional device speech recognition functions, such as “directions,” “dial,” and “help,” may be handled by the rule-based natural language-understanding engine 100. The machine learning-based natural language-understanding engine 140 may be responsible for all unstructured, free-form utterance patterns that cannot be defined by a specification.

In some embodiments, natural language understanding techniques are well suited to process utterances for executing functions onboard a vehicle system. In particular, they can provide scalable performance for domains with large populations of proper nouns, such as millions of points of interest (POIs for the user) or tens of millions of song titles. On the other hand, natural language understanding techniques struggle greatly with handling utterances for undefined functions, utterances that do not use specific terminology for vehicle functions, and utterances that are not executing an existing function but asking a variety of related questions. For example, if a system only defines the terms “open window” and “close window” and encounters the utterance “my window is broken”, the system is most likely to act on one of the two functions of opening and closing the window. Otherwise, the system may respond that the system does not understand or may perform an exception handling of the utterance as unsupported.

The processing of the natural language-understanding engines 100, 140 is defined as shown below in Equation 1.

$$Equation 1$$

$$N ( U ) = \{ \begin{matrix}{N}_{rules} ( U ) & if U is a predefined rule - base utterance \\ {N}_{m l} ( U ) & otherwise\end{matrix}$$

In some cases, the input utterance U is processed by a predefined rule-based natural language-understanding engine (Nᵣᵤₗₑₛ). Where the processing fails, the input utterance U is processed by a machine learning-based natural language-understanding engine (Nₘₗ).

The LLM agent 120 may complement the performance of the rule-based and machine learning-based hybrid natural language understanding models.

A LLM is trained by using a large amount of data. A large language model is typically finalized after fine instruction tuning to accurately understand and answer user queries and reinforcement learning to avoid giving human-preferred, biased, or harmful answers. The finished large language model has a generalized ability to understand complex and diverse human queries and perform new tasks. When applied to speech recognition, large language models have the advantage of understanding the context of a dialog and generating natural responses. The ability of large language models to understand and generate dialog has applications in a variety of fields and has the potential to replace or complement predefined systems.

An agent is a system that acts autonomously within a given environment in an AI system. The agent observes the environment by using sensors and selects the optimal behavior through a decision-making algorithm. Based on the optimal behavior, the agent influences the environment.

The LLM agent 120 is an artificial intelligence agent that operates by using a large language model. The LLM agent 120 may utilize natural language processing capabilities to perform various tasks. The LLM agent 120 may be utilized in a variety of applications such as virtual assistants, content generation, coding assistants, and the like, based on the ability to understand and generate text, respond in context, and provide information on a variety of topics.

The LLM agent 120 serves to determine whether the existing natural language-understanding engines 100, 140 can process utterances outside their processing range based on the existing dialog. The LLM agent 120 restores omitted content based on context or converts the representation of an utterance, even if it is somewhat different from the specification, to be the same as the representation of the specification-defined utterance if the utterance is semantically equivalent. If it is an ambiguity utterance, the LLM agent 120 may ask the user a reply question and continue the dialog to resolve the ambiguity. If the user's answer resolves the ambiguity, the LLM agent 120 may restore the utterance of the user to a specification-defined utterance that can be processed by the natural language-understanding engine based on the context. As a result, the LLM agent 120 solves the issues of co-reference resolution problem and ambiguity problem that occur in multi-turn dialogues, which are shortcomings of existing natural language understanding technologies.

A co-reference resolution problem is when a statement omits the content of a previous utterance or refers to it by using pronouns. For example, in the sentence “Maria looked tired. She got very little sleep last night,” “She” refers to “Maria.” The co-reference resolution problem is the task of identifying that “she” is “Maria.”

An ambiguity problem is when something can be interpreted in two or more ways. For example, the word “bank” can mean “river bank” or it can mean “money bank.” The meaning can change depending on the context.

To organically combine the LLM agent 120 with the existing natural language-understanding engines 100, 140, embodiments of the present disclosure place the LLM agent 120 between the rule-based natural language-understanding engine 100 and the machine learning-based natural language-understanding engine 140. The utterances that can be processed by the rule-based natural language-understanding engine are considered to be unambiguous utterances. Utterances inputted to the machine learning-based natural language-understanding engine 140 may contain ambiguous utterances that have not been filtered out by the rule-based natural language-understanding engine 100, which the LLM agent 120 determines based on the context of the dialog.

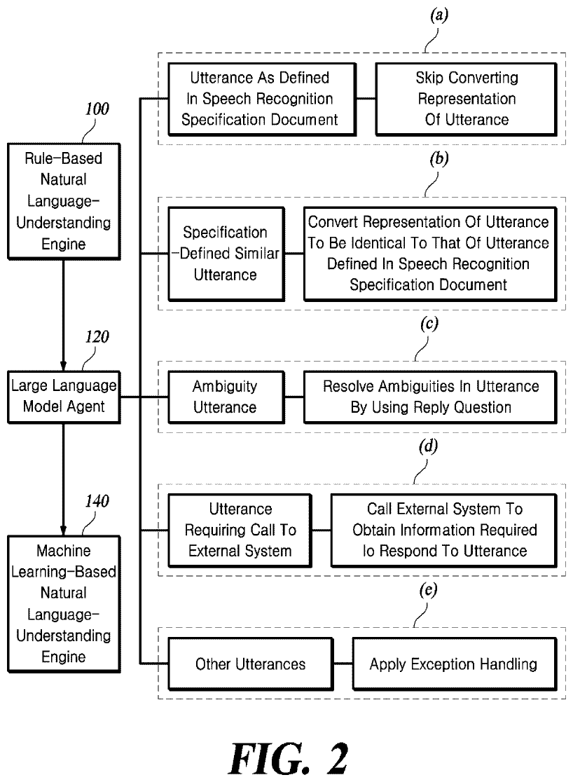

FIG. 2 is a diagram of an illustrative method performed by a large language model agent for processing an input utterance based on the context of the dialog.

The LLM agent 120 processes the input utterance based on the context of the dialog. The utterance processed by the LLM agent 120 may be efficiently processed by the machine learning-based natural language-understanding engine 140 because it is a sentence that has been resolved from co-reference resolution or ambiguity issues.

If the LLM agent 120 determines that the utterance is one that the conventional natural language-understanding engines 100, 140 cannot process, it may utilize other external systems 1500 for processing the answer or answer with a feature it does not support.

The existing natural language-understanding engines 100, 140 are unable to determine whether an out-of-specification utterance may be processed by the natural language-understanding engines 100, 140. Therefore, the LLM agent 120, which has strong linguistic knowledge, may process the out-of-specification utterance based on context. In particular, the multi-turn dialog method may convert the representation of the utterance sentence so that it can be processed by the existing natural language-understanding engines 100, 140.

The LLM agent 120 of at least one embodiment of the present disclosure has five types of functions. The functions include specification-defined utterance processing (L_{spec}(U)), specification-defined similar utterance processing (Lₛᵢₘᵢₗₐᵣ(U)), ambiguity utterance processing (L_{disambiguate}(U)), utterance processing that requires external knowledge (L_{extend}(U)), and other utterances processing (Lₒₜₕₑᵣ(U)). The functions of the LLM agent 120 of the embodiment of the present disclosure are not limited to these five.

The respective functions of the LLM agent 120 operate as shown in Equation 2 for non-specified utterances that the rule-based natural language-understanding engine 100 fails to process.

$$Equation 2$$

$$1. Verify that utterance U can be processed by a rule - based NLU :$$

$${L}_{rules} ( U ) \to processingcomplete$$

$$2. If utterance U is not processed by rule - based NLU ,$$

$$LLM Agent performs$$

$$context - based processing :$$

$$- {L}_{rules} ( U ) \to L ( U , C )$$

$$3. The LLM Agent performs the follwing processing based on utterance$$

$$U and context C :$$

$$L ( U , C ) \{ \begin{matrix}{L}_{spec} ( U ) & if U is a specification utterance \\ {L}_{similar} ( U ) & if U is similar to a specification utterance \\ {L}_{disambiguate} ( U ) & if U is ambiguous \\ {L}_{extend} ( U ) & if U requires external knowledge \\ {L}_{other} ( U ) & otherwise\end{matrix}$$

The user's utterance converted by the LLM agent 120 is ultimately used as input to the machine learning-based natural language-understanding engine 140 (see Equation 3 below).

$$L ( U , C ) \to {N}_{ml} ( L , ( U , C ) ) \qquad Equation 3$$

The LLM agent 120 is organically coupled with the existing natural language-understanding engines 100,140 by using the processes of Equation 2 and Equation 3.

FIG. 2, at (a), illustrates a specification-defined utterance processing method (L_{spec}(U)). The current utterance is checked to see if it is a full specification-defined utterance. If the current utterance is specification-defined, the LLM agent 120 passes the utterance sentence to the subsequent machine learning-based natural language-understanding engine 140 without any special processing.

FIG. 2, at (b), illustrates a specification-defined similar utterance processing method (Lₛᵢₘᵢₗₐᵣ(U)). The current utterance is checked to see if it has the same semantics as the full specification-defined utterance, even if it has a different expression. If the current utterance has the same meaning as the specification-defined utterance but a different expression, the LLM agent 120 considers it is within the functional range of the existing natural language-understanding engines 100, 140 and converts the current utterance to the representation of the specification-defined utterance. For example, assuming that “let's go to L-Tower” is not a specification-defined utterance, but semantically equivalent to the specification-defined representative command “take me to <destination>,” the LLM agent 120 passes a converted sentence “take me to L-Tower” to the subsequent machine learning-based natural language-understanding engine 140.

FIG. 2, at (c), illustrates an ambiguity utterance handling method (L_{disambiguate}(U)). When the user utterance is ambiguous and open to multiple interpretations, the LLM agent 120 asks a reply question based on the user utterance for clarification. For example, if the user says, “It's too loud,” this utterance is open to multiple interpretations. In this case, the LLM agent 120 clarifies the user's intent by asking a specific question, such as “Do you want to turn down the volume?” or “Is the noise outside the vehicle the problem?” After the ambiguity is resolved, the LLM agent 120 converts the utterance into a specification-defined utterance so that it can be processed by the existing natural language-understanding engines 100, 140. This method of handling ambiguous utterances preserves the continuity of the dialog and supports the user's desired exact functionality to be performed.

FIG. 2, at (d), illustrates a method of handling utterances that require external knowledge (L_{extend}(U)). The LLM agent 120 may generate a hallucination when it receives an utterance that requires certain external knowledge or real-time information. For example, if a user enters an utterance that requires real-time data, such as, “What is the current traffic situation?”, the LLM agent 120 may need to query a relevant API or database to answer based on the information obtained rather than answering directly to be accurate. In this case, the LLM agent 120 does not respond directly but categorizes it as an intent that requires interoperation with an external system. The subsequent system of a generative artificial intelligence 1400 may then call appropriate external knowledge systems 1500 to provide an appropriate response to the user based on the information obtained.

FIG. 2, at (e), illustrates other utterances processing method (Lₒₜₕₑᵣ(U)). The LLM agent 120 applies two types of exception handling to appropriately respond to utterances that cannot be handled by using the specification-defined similar utterance handling method (Lₛᵢₘᵢₗₐᵣ(U)) at FIG. 2(b) and the ambiguity utterance handling method (L_{disambiguate}(U)) at FIG. 2(c). If the utterance attempts to execute an unsupported function, the user is informed that the function is not supported. Alternatively, if the utterance is semantically unintelligible and cannot be processed by existing natural language-understanding engines 100,140, the user is informed that the utterance is unintelligible and asked to retry or provide more information. The other utterances processing method (Lₒₜₕₑᵣ(U)) can increase the flexibility of the system and provide richer responses to different user utterances, as illustrated in FIG. 2 at (e).

As shown in FIG. 1, the LLM agent 120 may be designed and implemented to include at least one of task prompts 1100, a speech recognition specification document 1200, a dialog history 1300, and few-shot learning.

The task prompts 1100 are input text used by the LLM agent 120 to guide its behavior when performing a particular task or operating in a particular context. The prompts serve to make the LLM agent 120 understand a given situation and guide the LLM agent 120 to respond or act accordingly.

The speech recognition specification document 1200 defines the design, implementation, functional requirements, performance criteria, and the like, of the speech recognition system 10. The speech recognition specification document 1200 clearly describes the behavior and performance goals of the speech recognition system 10, guiding developers to design and build the speech recognition system 10.

The dialog history 1300 is a record of the previous dialog between the user and the LLM agent 120. The dialog history 1300 maintains the context of the dialog and helps the LLM agent 120 to maintain a consistent dialog.

To maximize the performance of the LLM agent 120, the present disclosure designs the speech recognition specification document 1200, including a list of representative commands and proper nouns, and detailed task prompts. For example, the utterance “find me a gas station nearby” may be replaced with the representative command “show me a gas station” for processing. As a result, the LLM agent 120 is guided to handle a variety of utterances.

Few-shot learning refers to a technique in natural language processing and artificial intelligence where a model is taught to perform a specific task based on a small number of examples. To accurately process user utterances, the LLM agent 120 may include specific examples (few-shots) and processing methods. As a result, the system should behave more consistently. For example, a continuous utterance such as “Give me the Coffee Bean menu” followed by “Then Starbucks?” can be processed better based on context with similar examples alone. Examples and rules are dynamically selected based on the current input utterance and help the LLM agent 120 operate consistently across different situations and accurately determine user intent.

The speech recognition system 10, according to one embodiment of the present disclosure, may further include a dialog manager (DM) 160. The dialog manager 160 plays a key role in the conversational AI system to control the flow of the dialog, understand the user's intent, generate appropriate responses, and manage multi-turn dialogues. The dialog manager 160 can handle complex tasks by continuously tracking the state of the dialog, handling errors, and interoperating with the external systems 1500 as needed. As a result, the dialog manager 160 enables natural interaction with the user. The dialog manager 160 may output resultant signals to the vehicle, user device, or external server to perform processing to provide services that respond to the intent of the utterance or text inputted from the user. For example, if the service responding to the intent of the user is a vehicle-related control, the dialog manager 160 may transmit the resultant signal to the vehicle to perform the vehicle-related control.

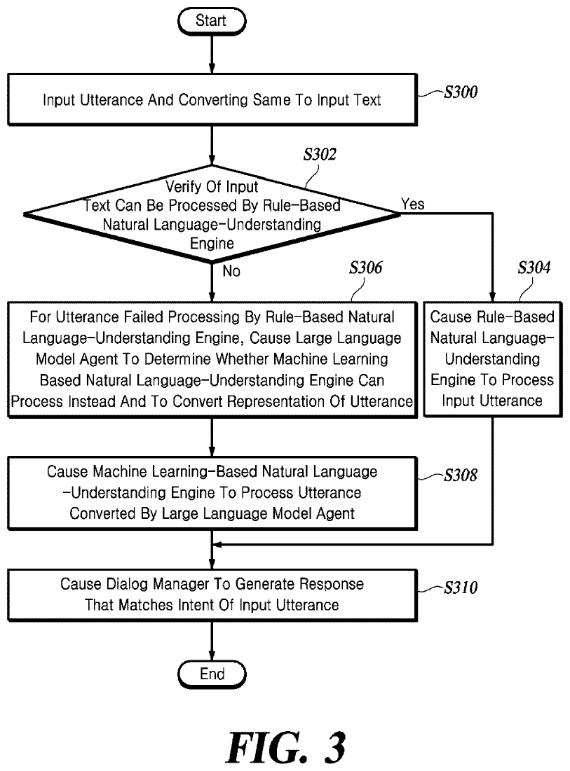

FIG. 3 is a flowchart of a speech recognition method implemented by a computer of a speech recognition system 10 according to at least one embodiment of the present disclosure.

The speech recognition method may include recognizing an utterance of a user when receiving an utterance input from the user (S300), understanding the recognized utterance, and providing a service corresponding to the utterance of the user. The speech recognition system may include a speech recognizer that converts the user's speech utterance into text.

The method further includes processing, i.e., attempting to process, the utterance by a rule-based natural language-understanding engine. The method further includes determining, i.e., verifying, whether the transcribed utterance can be processed by the rule-based natural language-understanding engine 100 (S302).

The method may further include, if the utterance can be processed by the rule-based natural language-understanding engine 100, processing the utterance (S304) and passing, i.e., inputting, the utterance to the dialog manager 160. The method further includes understanding, by the dialog manager 160, the intent of the input utterance and generating, by the dialog manager 160, an appropriate response (S310).

The method may further include determining, by the LLM agent 120, whether utterances other than those handled by the existing natural language-understanding engines 100, 140 may be processed based on the existing dialog. Based on the context, the LLM agent 120 restores the omitted content or converts the representation of an utterance, even if the representation is somewhat different from the specification, to be the same as the representation of the specification-defined utterance if they are semantically equivalent. If the utterance is ambiguous, the LLM agent 120 asks the user a reply question and continues the dialog in a way that resolves the ambiguity. If the user's answer has resolved the ambiguity, the LLM agent 120 may restore the user's utterance to the form of a specification-defined utterance for the natural language-understanding engine to process based on the context. This then resolves the technical issues of co-reference resolution or ambiguity in multi-turn dialogues, which is a drawback of existing natural language understanding technologies (S306).

The method may further include, if the utterance fails to be processed by the rule-based natural language-understanding engine 100, converting, by the LLM agent 120, the representation of the utterance for the machine learning-based natural language-understanding engine 140 to process the converted utterance (S308). In other words, the method may further include processing the utterance with a converted representation by the machine learning-based natural language-understanding engine 140.

The processed utterance is delivered from the machine learning-based natural language-understanding engine 140 to the dialog manager 160. The method may further include understanding, by the dialog manager 160, the intent of the input utterance and generating an appropriate response (S310).

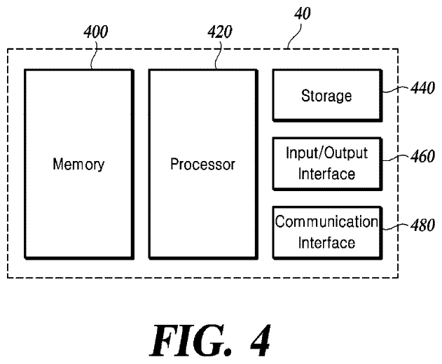

FIG. 4 is a schematic diagram of an illustrative configuration of a computing device 40 that may be used to implement the apparatuses and methods described herein.

The computing device 40 may include some or all of a non-transitory memory 400, a processor 420, a storage 440, an input/output interface 460, and a communication interface 480. The computing device 40 may be a stationary computing device, such as a desktop computer, server, or the like, as well as a mobile computing device, such as a laptop computer, smartphone, or the like. The computing device 40 may include any specialized hardware accelerator capable of efficiently processing computations on AI models. For example, the computing device 40 may include a graphic processing unit (GPU), a tensor processing unit (TPU), or a neural processing unit (NPU).

The memory 400 may store programs that when executed by the processor 420, cause the processor 420 to perform methods or operations in accordance with various embodiments of the present disclosure. For example, the programs may include a plurality of computer-executable instructions executable by the processor 420. The plurality of computer-executable instructions may be executed by the processor 420 to cause the processor 420 to perform the methods or operations described above. The memory 400 may be a single memory or a plurality of memories. In this case, the information required to perform the methods or operations according to various embodiments of the disclosure may be stored in a single memory or stored divisively among the plurality of memories. When the memory 400 is composed of a plurality of memories, they may be physically separated. The memory 400 may include at least one of volatile memory and non-volatile memory. The volatile memory may include static random access memory (SRAM) or dynamic random access memory (DRAM), for example, and the non-volatile memory may include flash memory, for example.

The processor 420 may include at least one core capable of executing at least one set of computer-executable instructions. The processor 420 may execute computer-executable instructions stored in the memory 400. The processor 420 may be a single processor or a plurality of processors.

The storage 440 maintains stored data even when power to the computing device 40 is interrupted. For example, the storage 440 may include non-volatile memory or may include a storage medium such as magnetic tape, optical disk, or magnetic disk. Programs stored in the storage 440 may be loaded into the memory 400 before execution by the processor 420. The storage 440 may store files written in a program language and programs generated by a compiler or the like may be loaded from the files into the memory 400. The storage 440 may store data to be processed by the processor 420 and/or data that has been processed by the processor 420.

The input/output interface 460 may provide an interface with an input device, such as a keyboard, mouse, etc. and/or with an output device, such as a display device, printer, etc. A user can trigger the execution of a program by the processor 420 via the input device and/or view the results of processing by the processor 420 via the output device.

The communication interface 480 may provide access to an external network. The computing device 40 may communicate with other devices via the communication interface 480.

The apparatus or method according to the present disclosure may have the respective components arranged to be implemented as hardware or software, or hardware and software combined. Additionally, each component may be functionally implemented by software, and a microprocessor may execute the function by software for each component when implemented.

Various illustrative implementations of the systems and methods described herein may be realized by digital electronic circuitry, integrated circuits, field-programmable gate arrays (FPGAs), application-specific integrated circuits (ASICs), computer hardware, firmware, software, and/or their combination. These various implementations can include those realized in one or more computer programs executable on a programmable system. The programmable system includes at least one programmable processor coupled to receive and transmit data and instructions from and to a storage system, at least one input device, and at least one output device, wherein the programmable processor may be a special-purpose processor or a general-purpose processor. The computer programs (which are also known as programs, software, software applications, or code) contain computer-executable instructions for a programmable processor and are stored in a “computer-readable recording medium.”

The computer-readable recording medium includes any type of recording device on which data that can be read by a computer system are recordable. Examples of computer-readable recording mediums include non-volatile or non-transitory media such as a ROM, CD-ROM, magnetic tape, floppy disk, memory card, hard disk, optical/magnetic disk, storage devices, and the like. The computer-readable recording mediums may further include transitory media such as a data transmission medium. Further, the computer-readable recording medium can be distributed in computer systems connected via a network, wherein the computer-readable codes can be stored and executed in a distributed mode.

Although the steps in the respective flowcharts/timing charts are described in this specification as being sequentially performed, they merely instantiate the technical idea of some embodiments of the present disclosure. Therefore, a person of ordinary skill in the pertinent art to the respective embodiments could perform the steps without departing from the idea and scope of the embodiments by changing the sequences described in the respective flowcharts/timing charts or by performing two or more of the steps in parallel. Hence, the steps in the respective flowcharts/timing charts are not limited to the illustrated chronological sequences.

Although various embodiments of the present disclosure have been described for illustrative purposes, those of ordinary skill in the art should appreciate that various modifications, additions, and substitutions are possible, without departing from the idea and scope of the claimed disclosure. Therefore, various embodiments of the present disclosure have been described for the sake of brevity and clarity. The scope of the technical idea of the embodiments of the present disclosure is not limited by the illustrations. Accordingly, one of ordinary skill in the art would understand the scope of the claimed disclosure is not to be limited by the above explicitly described embodiments but by the claims and equivalents thereof.

According to at least one embodiment of the present disclosure, a large language model may be utilized to address co-reference resolution issues and ambiguity issues that arise in processing multi-turn dialogues in a speech recognition system, thereby providing a response that is consistent with the intent of the utterance.

According to the embodiments, the present disclosure can solve the problem of cost-effectiveness of introducing a large language model into a speech recognition system.

The effects of the present disclosure are not limited to those mentioned above. Other effects not mentioned should be apparent to those of ordinary skill in the art from the above description.

REFERENCE NUMERALS

| | |
|---|---|
| 10: speech recognition system | 40: computing device |

What is claimed is:

1. A method implemented by a computer for a speech recognition system to process an utterance that is inputted, the method comprising operation steps of:
processing the utterance by a rule-based natural language-understanding engine;
when the rule-based natural language-understanding engine fails to process the utterance, converting a representation of the utterance and allowing a machine learning-based natural language-understanding engine to process the utterance by using a large language model agent (LLM agent); and
processing the utterance with a converted representation by the machine learning-based natural language-understanding engine.

2. The method of claim 1, wherein the LLM agent comprises:
an agent that is implemented by incorporating at least one of a speech recognition specification document, task prompts, a dialog history, or few-shot learning.

3. The method of claim 1, wherein the converting of the representation of the utterance comprises:
omitting the converting of the representation of the utterance if the utterance is defined in a speech recognition specification document.

4. The method of claim 1, wherein the converting of the representation of the utterance comprises:
when the utterance is a specification-defined similar utterance, converting the utterance to be equivalent to an instruction representation of the utterance as defined in a speech recognition specification document.

5. The method of claim 1, wherein the converting of the representation of the utterance comprises:
when the utterance is an utterance not defined in a speech recognition specification document and the LLM agent is unable to interpret a meaning of the utterance, causing the LLM agent to use a reply question to interpret the meaning of the utterance.

6. The method of claim 5, further comprising:
when the LLM agent fails to identify the meaning of the utterance by using the reply question, causing the LLM agent to notify a user that the meaning is an unintelligible utterance and request the user to retry or provide additional information.

7. The method of claim 1, wherein the converting of the representation of the utterance comprises:
when the utterance is an utterance that can only be responded to by utilizing information obtained by calling an external system, causing the LLM agent to call the external system to obtain information required for responding to the utterance.

8. The method of claim 1, wherein the converting of the representation of the utterance comprises:
when the utterance is an utterance not defined in a speech recognition specification document and the utterance relates to a feature not supported by the speech recognition system, notifying a user that the feature is not supported by the speech recognition system.

9. The method of claim 1, further comprising:
providing a dialog manager with the utterance processed by the machine learning-based natural language-understanding engine; and
causing the dialog manager to generate a response that corresponds to an intent of the utterance.

10. A non-transitory computer-readable recording medium having recorded thereon computer-executable instructions for executing each of the operation steps comprised in the method of claim 1.

11. An apparatus for processing an input utterance, the apparatus comprising:
at least one memory configured to store computer-executable instructions; and
at least one processor configured to execute the computer-executable instructions to cause the at least one processor to
process the utterance by a rule-based natural language-understanding engine,
when the rule-based natural language-understanding engine fails to process the utterance, convert a representation of the utterance to allow a machine learning-based natural language-understanding engine to process the utterance by use of a large language model agent (LLM agent), and
process the utterance with a converted representation by the machine learning-based natural language-understanding engine.

12. The apparatus of claim 11, wherein the LLM agent comprises:
an agent that is implemented by incorporation of at least one of a speech recognition specification document, task prompts, a dialog history, or few-shot learning.

13. The apparatus of claim 11, wherein the at least one processor is configured to further execute the computer-executable instructions to cause the at least one processor to:
omit converting the representation of the utterance if the utterance is defined in a speech recognition specification document.

14. The apparatus of claim 11, wherein converting the representation of the utterance comprises:
when the utterance is a specification-defined similar utterance, converting the utterance to be equivalent to an instruction representation of the utterance as defined in a speech recognition specification document.

15. The apparatus of claim 11, wherein converting the representation of the utterance comprises:
when the utterance is an utterance not defined in a speech recognition specification document and the LLM agent is unable to interpret a meaning of the utterance, causing the LLM agent to use a reply question to interpret the meaning of the utterance.

16. The apparatus of claim 15, wherein the at least one processor is configured to further execute the computer-executable instructions to cause the at least one processor to:
respond to the LLM agent failing to identify the meaning of the utterance by using the reply question; and
cause the LLM agent to notify a user that the meaning is an unintelligible utterance and request the user to retry or provide additional information.

17. The apparatus of claim 11, wherein converting the representation of the utterance comprises:
when the utterance is an utterance that can only be responded to by utilizing information obtained by calling an external system, causing the LLM agent to call the external system to obtain information required for responding to the utterance.

18. The apparatus of claim 11, wherein converting the representation of the utterance comprises:
when the utterance is an utterance not defined in a speech recognition specification document and the utterance relates to a feature not supported by the apparatus, notifying a user that the feature is not supported by the apparatus.

19. The apparatus of claim 11, wherein the at least one processor is configured to further execute the computer-executable instructions to cause the at least one processor to:
provide a dialog manager with the utterance processed by the machine learning-based natural language-understanding engine; and
cause the dialog manager to generate a response that corresponds to an intent of the utterance.
